(19) United States
(12) Patent Application Publication
(10) Pub. No.: US 2015/0308486 A1
(43) Pub. Date: Oct. 29, 2015

(54) Threaded Structures Joined Using Adhesive-Filled Balls

(71) Applicant: APPLE INC., Cupertino, CA (US)

(72) Inventors: Colin M. Ely, Cupertino, CA (US); David G. Havskjold, Sunnyvale, CA (US)

(73) Assignee: APPLE INC., Cupertino, CA (US)

(21) Appl. No.: 14/262,604

(22) Filed: Apr. 25, 2014

(51) Int. Cl. F16B 39/22; B29C 65/52; B29C 65/56

(52) U.S. Cl. CPC F16B 39/225; B29C 65/561; B29C 65/52; B29K 2105/0097

(57) ABSTRACT

Threaded fasteners may be used in assembling structures. A threaded fastener such as a threaded screw may be used to secure one structure to another structure or may have a radially enlarged portion that retains a rotating member to the threaded fastener. A known quantity of thread-locking adhesive may be inserted into a threaded opening by placing an adhesive-filled ball within the threaded opening. A threaded fastener may then be screwed into the opening to burst the ball and release the adhesive. Arrangements in which the adhesive-filled ball has multiple chambers or is coated with a reactant may also be used. Two-part adhesives may be deployed by inserting two balls in an opening, one of which is filled with an adhesive material of a first type and another of which is filled with an adhesive material of a second type.

### BACKGROUND

This relates generally to joining structures in electronic devices, and, more particular, to using adhesive to secure threaded joints.

Electronic devices often include fasteners. For example, screws and other threaded fasteners may be used to attach components together. Fasteners may become dislodged over time. It may therefore be desirable to use adhesive to help maintain screws and other components in a locked configuration.

Liquid thread-locking adhesives are sometimes used to secure threaded fasteners. Challenges can arise, however, when attempting to accurately dispense small amounts of thread-locking adhesive. If care is not taken, insufficient adhesive will be dispensed so that a weak joint is formed or too much thread-locking adhesive will be applied so that a joint is flooded with excess material.

Compounds that include crushable microspheres can be used as an alternative. In some arrangements, crushable microspheres of about 20 microns in diameter may be used to release one of the parts of a two-part epoxy. A locking joint may be formed by crushing the microspheres by inserting a threaded screw into a threaded hole. Because the microspheres are small, the microspheres can gather in unreachable recesses of a threaded opening, leading to incompletely locked joints.

It would therefore be desirable to be able to provide improved ways to dispense adhesive for use in locking threaded fasteners and other structures in electronic devices.

### SUMMARY

Threaded fasteners may be used in assembling structures in an electronic device. For example, a threaded fastener such as a threaded screw may be used to secure a first structure to a second structure. In this type of arrangement, the shaft of the threaded screw may pass through an unthreaded opening in the first structure and may be received within a threaded opening in the second structure. As another example, a portion of the threaded shaft of a threaded fastener may be radially enlarged. The radially enlarged portion may be used to retain a rotating member on the threaded fastener.

A known quantity of thread-locking adhesive may be inserted into a threaded opening by placing an adhesive-filled ball within the threaded opening. A threaded fastener may then be screwed into the opening to burst the ball and release the thread-locking adhesive. If desired, coatings may be placed in the opening or on the threaded fastener to assist in forming a satisfactory adhesive bond.

Arrangements in which the adhesive-filled ball has multiple chambers or is coated with a reactant that facilitates adhesive joint formation may also be used. Two-part adhesives may be deployed by inserting two balls in an opening, one of which is filled with an adhesive material of a first type and another of which is filled with an adhesive material of a second type. The first and second types of adhesive materials may be respective first and second parts of a two-part adhesive.

### BRIEF DESCRIPTION OF THE DRAWINGS

FIG. 1 is a schematic diagram of an illustrative electronic device of the type in which structures may be joined using adhesive such as thread-locking adhesive in accordance with an embodiment.

FIG. 2 is a perspective view of an illustrative electronic device of the type in which structures may be joined using adhesive such as thread-locking adhesive in accordance with an embodiment.

FIG. 3 is a cross-sectional side view of an illustrative screw and a structure with a mating threaded opening in accordance with an embodiment.

FIG. 4 is a cross-sectional side view of an illustrative screw being used to secure structures together in accordance with an embodiment.

FIG. 5 is a cross-sectional side view of an illustrative screw and associated nut in accordance with an embodiment.

FIG. 6 is a cross-sectional side view of a threaded fastener with an enlarged head portion in accordance with an embodiment.

FIG. 7 is a cross-sectional side view of a threaded fastener with a radially enlarged portion that is used to retain a rotating member on the threaded fastener in accordance with an embodiment.

FIG. 8 is a perspective view of illustrative equipment of the type that may be used in forming balls filled with thread-locking adhesive in accordance with an embodiment.

FIG. 9 is a cross-sectional side view of an illustrative adhesive-filled ball in accordance with an embodiment.

FIG. 10 is a cross-sectional side view of an illustrative adhesive-filled ball having two adhesive components in respective chambers of the ball in accordance with an embodiment.

FIG. 11 is a diagram of illustrative equipment of the type that may be used to insert adhesive-filled balls into threaded openings in accordance with an embodiment.

FIG. 12 is a diagram showing how computer-controlled equipment may be used to insert a threaded fastener into an opening in which equipment of the type shown in FIG. 11 has inserted an adhesive-filled ball in accordance with an embodiment.

FIG. 13 is a diagram showing how the ball of FIG. 12 may be broken upon insertion of a threaded fastener thereby releasing thread-locking adhesive from the interior of the ball and forming an adhesive joint in accordance with an embodiment.

FIG. 14 is a cross-sectional side view of an illustrative threaded opening that is being coated with an illustrative coating in accordance with an embodiment.

FIG. 15 is a cross-sectional side view of the coated opening of FIG. 14 during insertion of an adhesive-filled ball in accordance with an embodiment.

FIG. 16 is a cross-sectional side view of the threaded fastener and opening of FIG. 15 following rupture of the adhesive-filled ball and formation of an adhesive joint in accordance with an embodiment.

FIG. 17 is a cross-sectional side view of an illustrative threaded opening that has been filled with two balls containing adhesive material such as first and second parts of a two-part adhesive in accordance with an embodiment.

FIG. 18 is a cross-sectional side view of an illustrative threaded opening that has been filled with a reactant-coated adhesive-filled ball in accordance with an embodiment.

FIG. 19 is a cross-sectional side view of an illustrative unthreaded opening and mating unthreaded fastener being joined using an adhesive-filled ball in accordance with an embodiment.

FIG. 20 is a cross-sectional side view of a structure with protrusions and a mating structure with recesses of the type that may be joined using adhesive-filled balls in accordance with an embodiment.

FIG. 21 is a flow chart of illustrative steps involved in forming adhesive joints between threaded structures and other structures in an electronic device in accordance with an embodiment.

### DETAILED DESCRIPTION

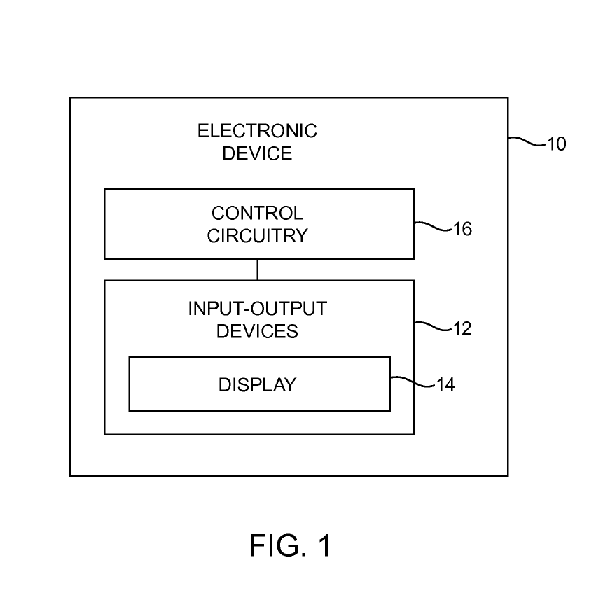

An illustrative electronic device of the type that may have structures joined with adhesive is shown in FIG. 1. As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio codec chips, application specific integrated circuits, etc.

Input-output circuitry in device 10 such as input-output devices 12 may be used to allow data to be supplied to device 10 and to allow data to be provided from device 10 to external devices. Input-output devices 12 may include buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. The outer surface of display 14 may be covered with a transparent protective cover layer.

Control circuitry 16 may be used to run software on device 10 such as operating system code and applications. During operation of device 10, the software running on control circuitry 16 may display images on display 14 in input-output devices.

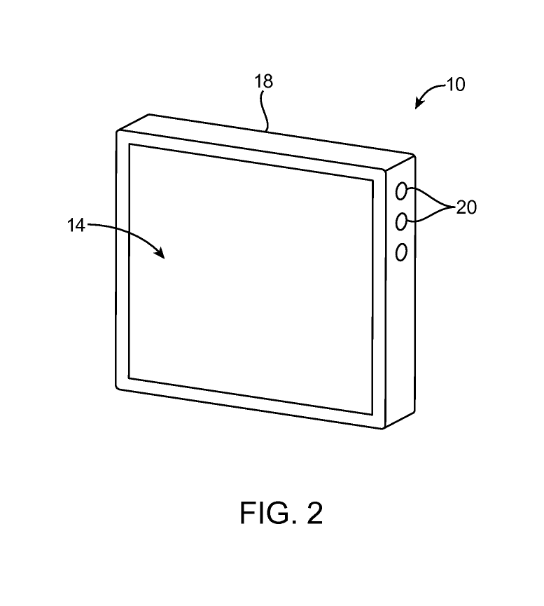

A perspective view of an illustrative electronic device such as device 10 of FIG. 1 is shown in FIG. 2. Device 10 of FIG. 2 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television or other display for video, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. The configuration of device 10 that is shown in FIG. 2 (e.g., a portable device configuration in which device 10 is a cellular telephone, media player, wrist device, tablet computer, or other portable computing device) is shown as an example. Other configurations may be used for device 10 if desired.

Device 10 may have one or more displays such as display 14 mounted in housing structures such as housing 18. Housing 18 of device 10, which is sometimes referred to as a case, may be formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 18 is formed from a single structural element (e.g., a piece of machined metal or a piece of molded plastic) or may be formed from multiple housing structures (e.g., outer housing structures that have been mounted to internal frame elements or other internal housing structures). Controls 20 may be mounted on housing 14. Controls 20 may include buttons, rotatable knobs, sliders, touch sensors, input-output ports for cables or other accessories, light-based input-output components, or other components for controlling the operation of device 10 (see, e.g., input-output devices 12 of FIG. 1).

Fasteners and adhesive may be used when fastening together structures of device 10 (e.g., the structures of FIGS. 1 and 2 and/or other structures in device 10). As an example, threaded fasteners such as screws or other threaded components may be screwed into mating threaded openings (e.g., screw holes) in structures such as housing structures and other portions of device 10. To help retain the screwed structures together in an assembled state, it may be desirable to form adhesive joints that hold the threads of the fastener and the threaded opening together.

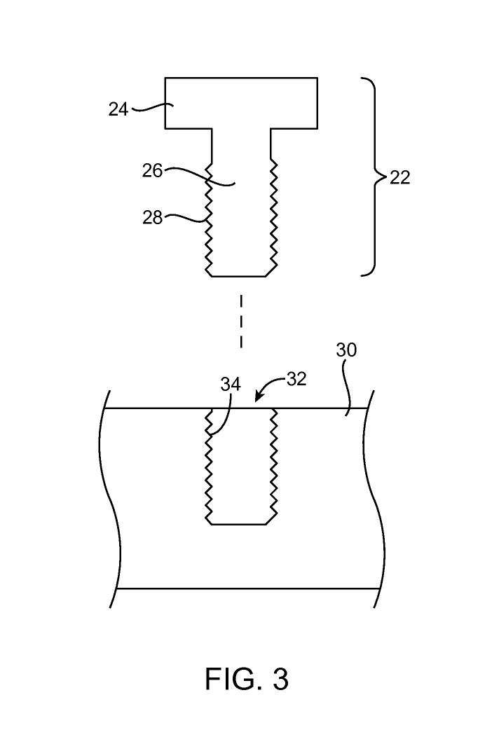

Illustrative threaded structures of the type that may be joined when assembling device 10 are shown in FIGS. 3, 4, 5, 6, and 7.

In the example of FIG. 3, a threaded fastener such as screw 22 is being joined with structure 30. Screw 22 may include head 24 and shaft 26. Shaft 26 may be a threaded shaft having threads 28 that mate with corresponding threads 34 within threaded opening 32 of structure 30. Screw 22 and structure 30 may be formed from metal, plastic, or other materials. Structure 30 may form part of device housing 18 or other structure within device 10. Head 24 of screw 22 may have recessed portions for receiving a screwdriver tip and/or may have flat sides to engage a wrench. The diameter of shaft 26 and threaded opening 32 may be 1-2 mm, more than 2 mm, less than 2 mm, or other suitable size.

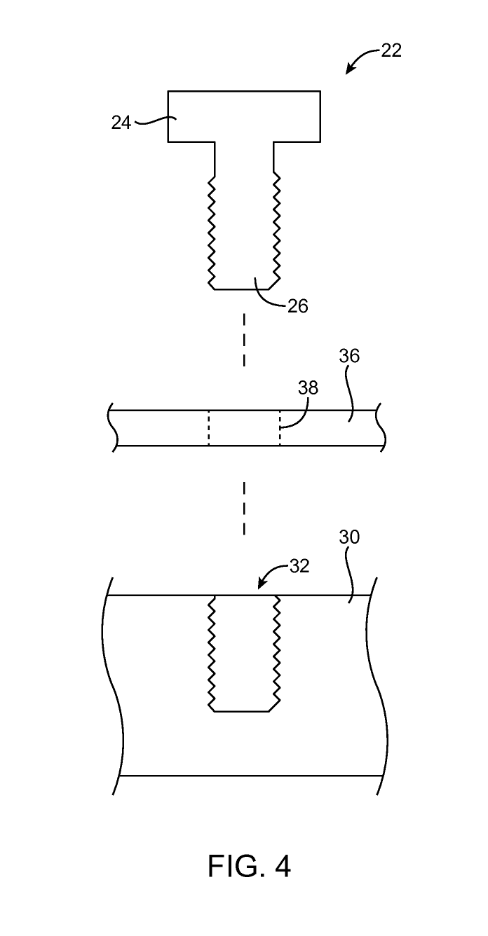

As shown in FIG. 4, one or more additional structures may be interposed between head 24 of screw 22 and structure 30. In the example of FIG. 4, structure 36 has an unthreaded opening such as through-hole 38. Through-hole 38 has a diameter that is sufficiently large to allow shaft 26 to pass through structure 36. Threaded shaft 26 may be screwed into threaded opening 32 of structure 30 after passing through opening 38. When screw 22 is interested into opening 32 in this way, screw head 24 will hold structure 36 against structure 30. Structure 36 may be a washer, part of a housing such as housing 18, part of an internal component, or other structure in device 10.

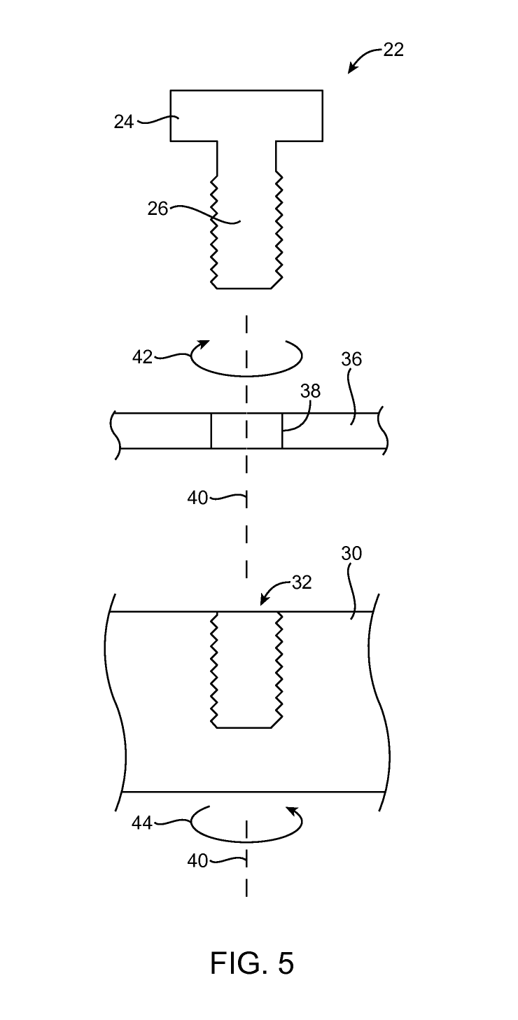

Another illustrative arrangement involving fastener joints in device 10 is shown in FIG. 5. With the illustrative configuration of FIG. 5, screw shaft 26 passes through unthreaded opening (through-hole) 38 and into threaded opening 32 in structure 30. Structure 30 may be a nut having screwdriver grooves or flat sides to engage a wrench. As shown in FIG. 5, screw shaft 26 and threaded opening 32 of nut 30 may be aligned along axis 40. When joining screw 22 and nut 30, screw 22 may be rotated about axis 40 in direction 42 and/or nut 30 may be rotated about axis 40 in direction 44 (as examples).

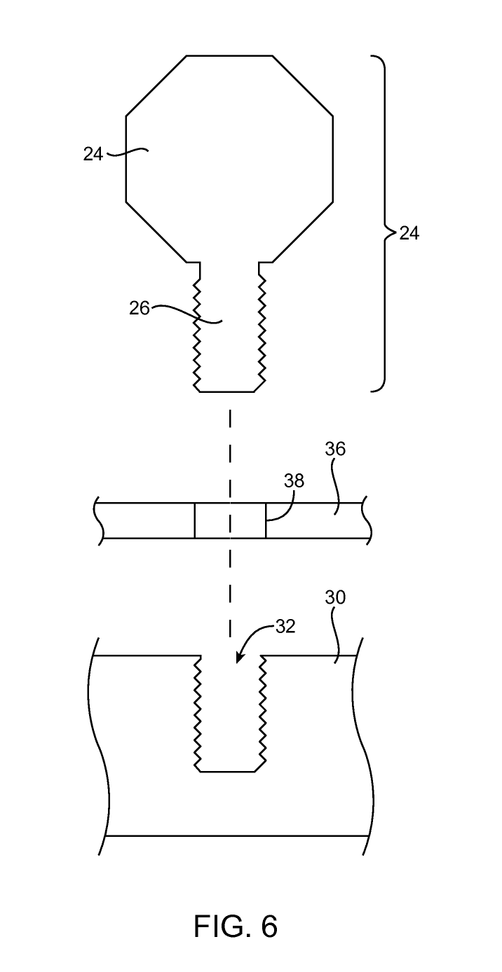

FIG. 6 shows how threaded fastener 22 may have an enlarged head structure (structure 24). Head structure 24 may have features (e.g., openings, grooves, etc.) that allow additional structures to be mounted to screw 24. Screw shaft 26 may be screwed into threaded opening 32 of structure 30. If desired, interposed structure such as structure 36 may be attached to structure 30 in this way (e.g., by allowing shaft 26 to pass through opening 38).

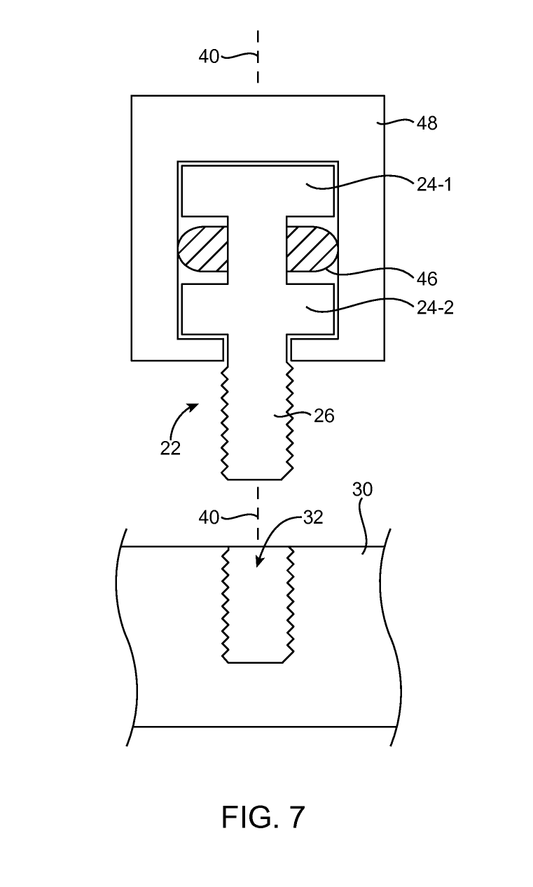

If desired, screws 22 may be used as a mounting structure for additional components. Consider, as an example, the configuration of FIG. 7. As shown in FIG. 7, threaded structure 22 (e.g., a screw or other threaded fastener) may have a threaded shaft such as shaft 26 that is received within threaded opening 32 of structure 30. Structure 30 may be a portion of housing 18 of device 10 (e.g., a metal housing or other housing structure), or may be other metal or plastic structure in device 10 (as examples). Screw 22 may have two radially enlarged portions such as portion 26-1 and 26-2. An elastomeric structure such as elastomeric O-ring 46 may wrap around the portion of shaft 26 that lies between enlarged portions 26-1 and 26-2. Hollow cylindrical member 48 may be mounted to screw 22 and may rotate freely about axis 40 relative to screw 22. O-ring 46 may create a moisture-tight seal with the inner surface of member 48. Radially enlarged portion 24-2 of screw 22 and shaft 26 may retain rotating structure 48 on shaft 26 and screw 22. To prevent the rotational movement of member 48 relative to screw 22 from dislodging screw 22 and to prevent screws 22 of FIGS. 3, 4, 5, and 6 or other threaded structures from becoming dislodged from opening 32, adhesive may be used to lock the threads of screw 22 and opening 32 together.

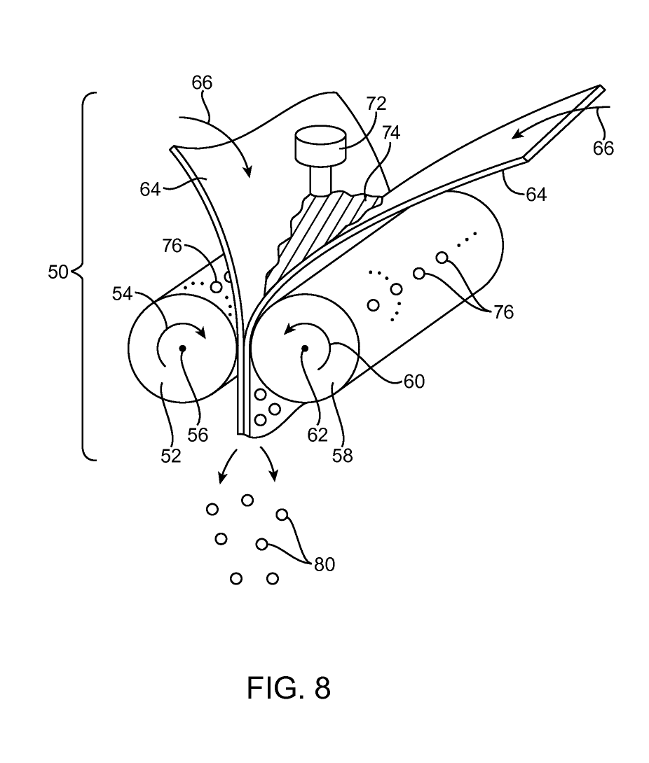

To assist in dispensing an accurate amount of adhesive, it may be desirable to encase one or more parts of the adhesive within a breakable structure such as a hollow ball or other burstable container having walls formed from polymer, glass, or other breakable material. Equipment of the type that may be used in forming adhesive-filled balls or other burstable containers filled with adhesive material is shown in FIG. 8.

As shown in FIG. 8, equipment 50 may include heated rollers such as rollers 52 and 58. Roller 52 may rotate in direction 54 about axis 56. Roller 58 may rotate about axis 62 in direction 60. Polymer sheets 64 (or sheets of other suitable shell material for forming adhesive-filled balls) may be fed into rollers 52 and 62 in directions 66. Adhesive dispenser 72 may dispense liquid adhesive 74 between sheets 64. Rollers 52 and 58 may have semispherical depressions 76 that mate to form spheres. As sheets 64 are compressed between rollers 52 and 58, adhesive 74 becomes encapsulated within spherical balls 80, which are cut away from the remainder of sheets 64. Due to the heat of rollers 52 and 58, the polymer material of the two sheets 64 that have been fed between rollers 52 and 58 is sealed together to prevent leakage of adhesive 74 from the interior of balls 80. Because balls 80 contain liquid adhesive, balls 80 are sometimes referred to as adhesive-filled balls. Balls 80 may be spherical or may have other suitable container shapes (e.g., the shape of a rectangular box, etc.).

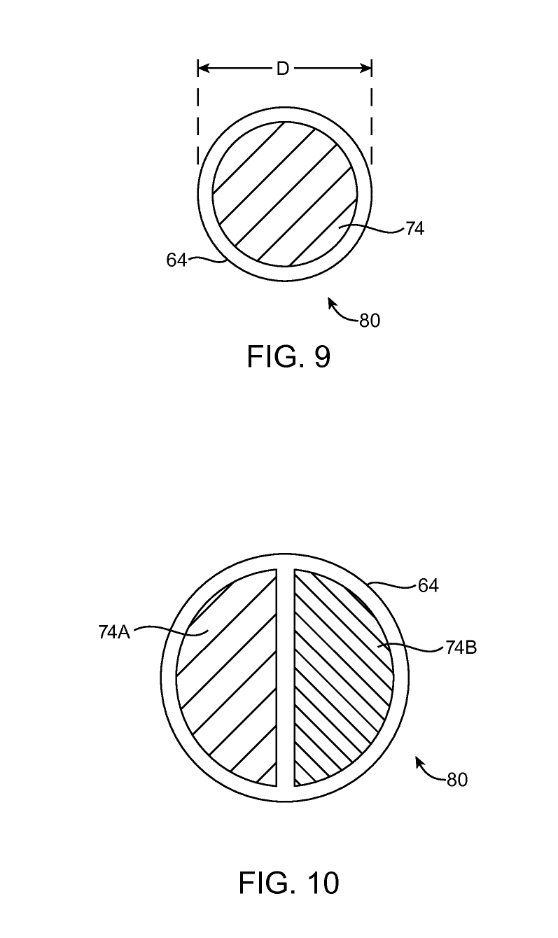

A cross-sectional side view of an illustrative adhesive-filled ball is shown in FIG. 9. As shown in FIG. 9, adhesive 74 may be enclosed within a shell such as shell 64. Shell 64 may be formed from a material such as plastic (e.g., a polymer material that can be processed using equipment of the type shown in FIG. 8 or other suitable polymer), glass, etc. Examples in which shell 64 is formed from plastic may sometimes be described herein as an example.

Balls such as illustrative ball 80 of FIG. 9 may be characterized by a ball diameter D that is comparable to the diameter of opening 32. For example, D may be 60-99% of the diameter of opening 32, may be 70-90% of the diameter of opening 32, may be at least 50% of the opening diameter, may be at least 80% of the opening diameter, etc. For example, D may be 1-2 mm, may be 0.3-1.5 mm, may be 0.5 to 1 mm, may be 0.6 to 1.4 mm, may be 0.7 to 2.5 mm, may be 0.8 to 0.9 mm, may be 0.6 to 1.1 mm, may be more than 0.2 mm, may be more than 0.5 mm, may be more than 1 mm, may be more than 1.5 mm, may be less than 4 mm, may be less than 3 mm, or may be less than 2 mm. An advantage of using a ball size that is comparable to the size of opening 32 is that this type of size may facilitate the process of dispensing a known number of balls 80 in to opening 32. In particular, ball sizes comparable to the size of opening 32 make it possible to place only a single ball 80 into opening 32 before the ball is burst (i.e., so that the single ball is the only ball in the opening before the screw is inserted) or make it possible to place only a pair of balls 80 into opening 32 before screw insertion.

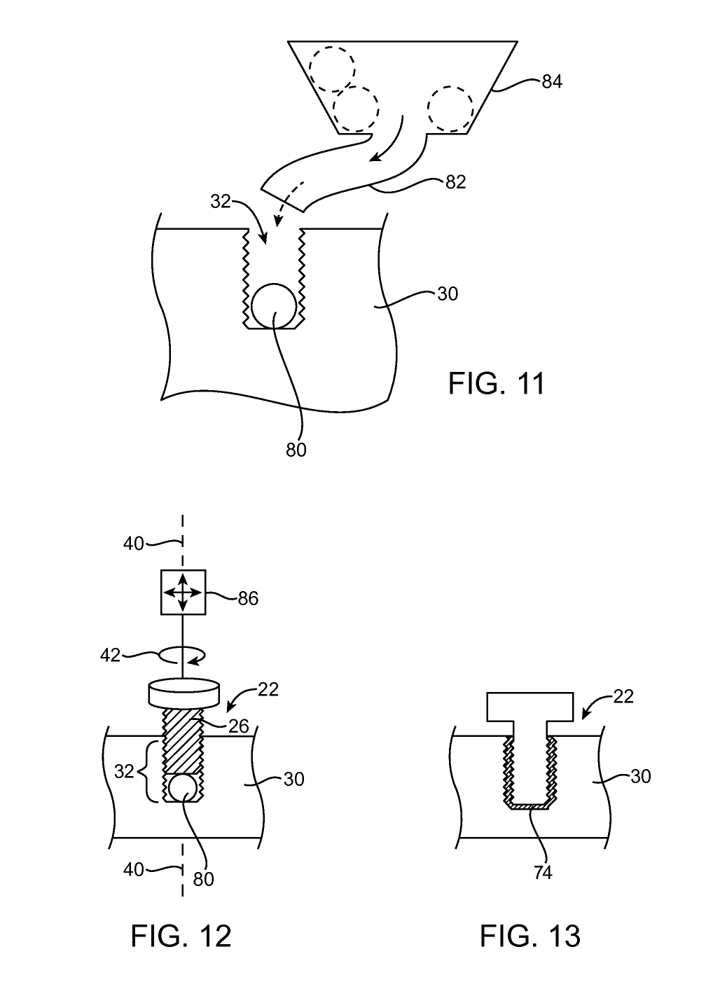

FIG. 11 is a diagram showing how adhesive filled balls 80 may be dispensed from a storage structure such as hopper 84 using a dispensing structure such as tube 82. Tube 82 may be used to place one of balls 80 into the bottom of each opening 32 in device 10 (i.e., tube 82 may be used to ensure that fewer than two balls are inserted into opening 32 before fastener insertion). Balls 80 may be dispensed using compressed gas, using a mechanical positioner, using a needle dispenser, as part of a liquid or paste, or using other suitable equipment. The use of tube 82 (e.g., a gravity fed tube) to place ball 80 within opening 32 of FIG. 11 is merely illustrative.

After loading a controlled number of balls (i.e., one or more balls such as ball 80 of FIG. 11) into opening 32, screw 26 may be installed within opening 32. If desired, a manually controlled screwdriver or other tool may be used to install screw 22. As shown in FIG. 12, computer-controlled equipment 86 may be used to rotate screw 22 in direction 42 about axis 40, thereby causing the threads of screw 22 to engage the mating threads in threaded opening 32 of structure 30. This drives screw 22 into opening 32 and crushes ball 80. As ball 80 is compressed by shaft 26 of screw 22, shell 64 of ball 80 ruptures and releases adhesive 74. The quantity of adhesive 74 that is contained in ball 80 is appropriate for forming a satisfactory adhesive joint between the threads of screw 22 and the threads of opening 32 (see, e.g., adhesive joint 74 of FIG. 13). Because each ball 80 that is dispensed in this way has an appropriate amount of adhesive 74, situations in which too little adhesive or too much adhesive is dispensed can be avoided.

Adhesive 74 may be an acrylate polymer adhesive (e.g., a methacrylate-based adhesive that cures anaerobically) or may be other suitable adhesive (e.g., a one-part adhesive, a two-part adhesive, etc.). Adhesive 74 may be formulated to serve as a thread-locking material (i.e., an adhesive that binds joined threads such as the threads on screw 22 and opening 32) and is therefore sometimes referred to as threadlocker or thread-locking adhesive.

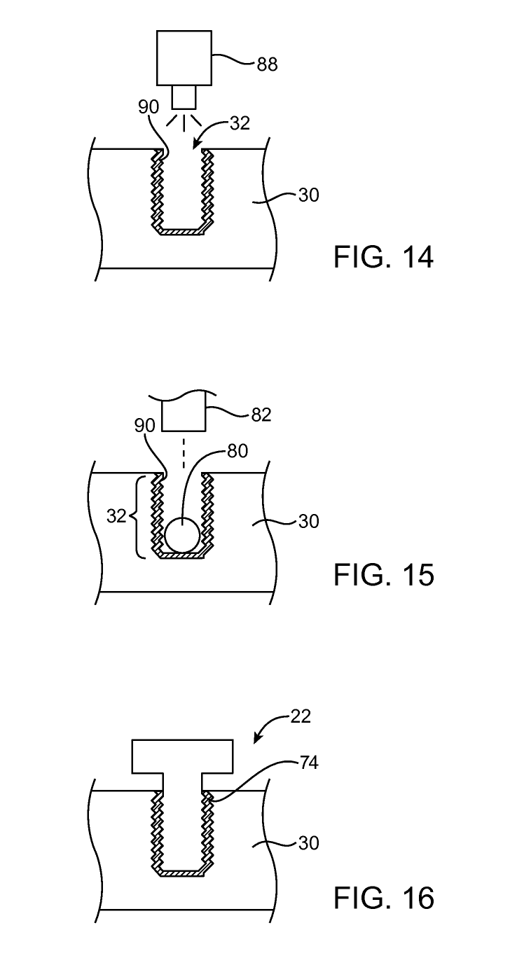

If desired, the interior of opening 32 may be coated with a coating before ball 80 is inserted in opening 32. As shown in FIG. 14, for example, nozzle 88 may be used to form coating 90 on the interior surfaces (i.e., the threads) of opening 32. Coating 90 may be a first part of a two-part adhesive (whereas adhesive 74 may be the corresponding second part of the two-part adhesive) or coating 90 may be material for enhancing adhesive bond strength (e.g., an adhesion promoter, a cure promoting material, or other reactant). After coating 90 is formed in opening 32, ball 80 may be inserted into opening 32 (e.g., using tube 82), as shown in FIG. 15. When screw 22 is installed in opening 32, adhesive 74 from the interior of ball 80 is released and, in combination with coating 90, forms adhesive joint 74 of FIG. 16, thereby locking screw 22 in opening 32.

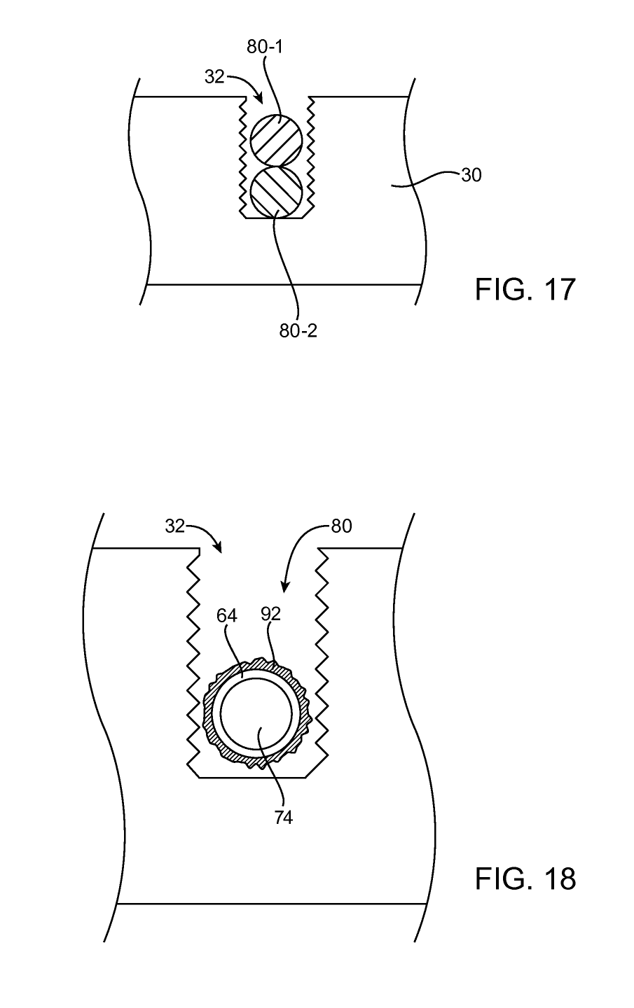

FIG. 17 shows how two adhesive-filled balls 80-1 and 80-2 may be placed in opening 32. The two balls may contain the same type of adhesive 74 or may contain two parts of a two-part adhesive (as an example). To prevent over-filling the threads with adhesive, only two balls (i.e., less than three balls) or other small fixed and predetermine number of balls 80 may be inserted into opening 32. This ensures that a known amount of one-part adhesive or two-part adhesive (as in the example of FIG. 17) is dispensed.

As shown in FIG. 18, coating 92 may be formed on the exterior surface of shell 64. When ball 80 of FIG. 18 ruptures, adhesive 74 from the interior of ball 80 will be released and can mix with coating 92. Coating 92 may be a reactant that reacts with adhesive material 74 and helps to form a satisfactory thread locking bond between screw 22 and structure 30.

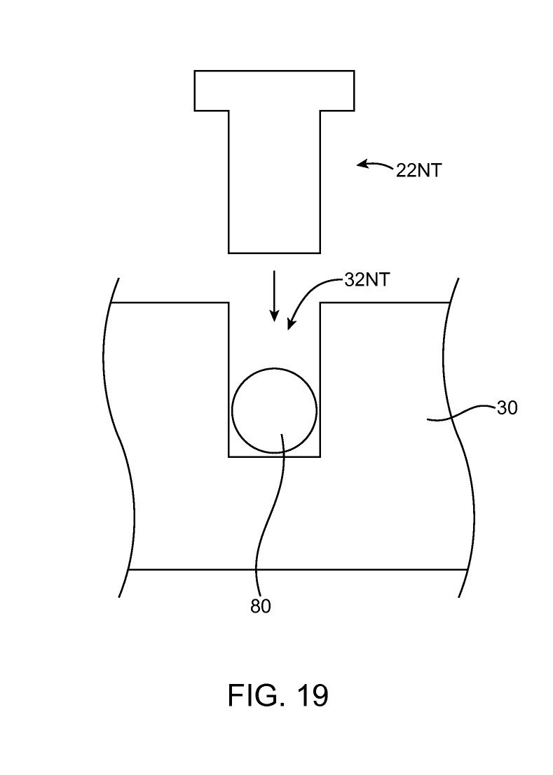

FIG. 19 is a cross-sectional side view of illustrative device structure showing how a non-threaded fastener such as fastener 22NT may be mounted in a non-threaded opening such as non-threaded opening 32NT of structure 30 by bursting liquid adhesive-filled ball 80. Fastener 22NT may be a pin or other fastener (e.g., a pin with a round shaft, etc.).

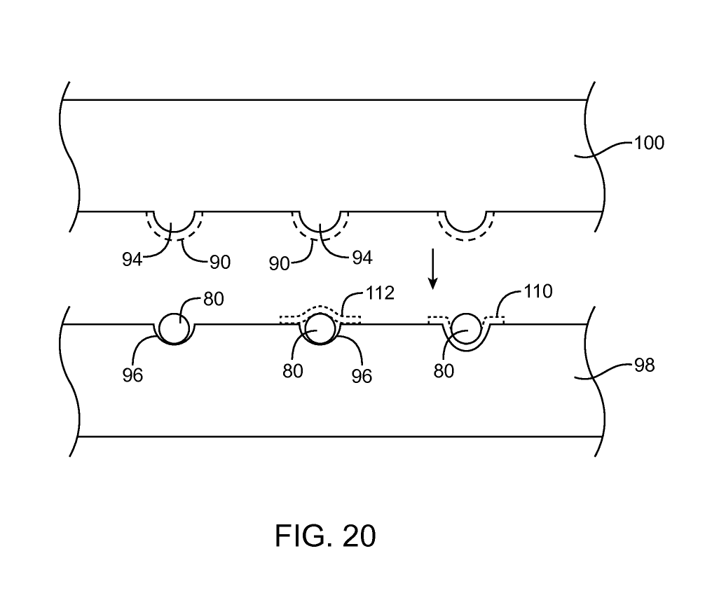

In the illustrative configuration of FIG. 20, device structures 100 and 98 are being joined using adhesive-filled balls 80. Structures 100 and 98 of FIG. 20 and the other structures being joined using adhesive 74 may be housing structures, structures associated with electrical components in device 10, structures associated with internal mounting brackets and support structures in device 10, structures associated with mechanical parts of device 10, or other suitable structures for device 10. Structure 100 of FIG. 20 has protrusions 94. Structure 98 has mating recesses 96. Adhesive filled balls 80 may be placed in recesses 96 using a dispenser such as tubing 82 of FIG. 11 or other equipment. If desired, coatings such as coating 90 (e.g., part of a two-part adhesive, an adhesion promoter or other reactant, etc.) may be formed on protrusions 94 of structure 100 or in recesses 96 prior to mating structures 100 and 98 (or may similarly be formed on fasteners 22 and/or the interior of opening 32 before fasteners 22 are inserted in openings 32). When protrusions 94 are placed in recesses 96, adhesive-filled balls 80 will rupture and release adhesive 74, thereby attaching structures 100 and 98 together. If desired, adhesive such as adhesive 110 may be placed in recesses 96 prior to placing balls 80 in recesses 96 to help hold balls 80 in place. Adhesive 110 may be pressure sensitive adhesive, liquid adhesive, etc. Balls 80 may also be retained by a layer of pressure sensitive adhesive (see, e.g., layer 112) that covers balls 80.

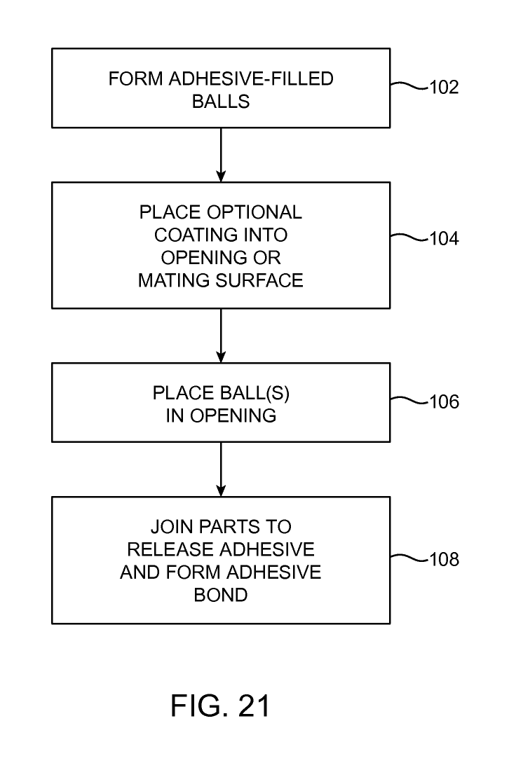

Illustrative steps involved in forming structures of the type described in connection with FIGS. 1-20 are shown in FIG. 21.

At step 102, sheets of material such as polymer sheets 64 of FIG. 8 or other shell material may be used to form shells enclosing liquid adhesive material (e.g., thread-locking adhesive 74), thereby forming adhesive-filled balls 80. Balls 80 may contain a single adhesive-filled chamber or multiple adhesive-filled chambers (e.g., first and second chambers containing different respective first and second adhesive materials such as first and second parts of a two-part adhesive). A reactant coating may optionally be formed on the exterior surface of the balls.

At step 104, optional coating material (see, e.g., coating 90 of FIG. 14 or coating 90 of FIG. 20) may be formed on screw 22 and/or the interior of opening 32.

At step 106, ball(s) 80 may be inserted in opening 32 (or a recess such as recess 96 of structure 98 in the example of FIG. 20). For example, tubing 82 or other dispensing equipment may be used to insert only a single ball (or only two balls or other known number of balls 80) into opening 32. The amount of adhesive 74 in each ball can be controlled when forming balls 80, so the ability to place a known number of balls into opening 32 (e.g., fewer than two balls, fewer than three balls, etc.) allows a corresponding known amount of adhesive 74 to be introduced to each opening 32, thereby ensuring satisfactory adhesive joint formation.

At step 108, the parts to be joined can be mated. For example, a threaded structure such as screw 22 can be screwed into threaded opening 32, thereby rupturing adhesive-filled ball(s) 80 and releasing a desired amount of adhesive 74. As the adhesive cures, the threads of screw 22 will be joined to the threads of threaded opening 32 and screw 22 will be locked in place relative to structure 30.

The foregoing is merely illustrative and various modifications can be made by those skilled in the art without departing from the scope and spirit of the described embodiments. The foregoing embodiments may be implemented individually or in any combination.

What is claimed is:

1. Apparatus, comprising:
a structure with a threaded opening;
a threaded shaft that is inserted into the opening;
a ruptured adhesive-filled ball that has released thread-locking adhesive to form an adhesive joint that locks the threaded shaft to the structure.

2. The apparatus defined in claim 1 wherein the threaded shaft forms part of a threaded fastener and wherein the ruptured adhesive-filled ball is the only adhesive-filled ball in the threaded opening.

3. The apparatus defined in claim 2 wherein the structure comprises an electronic device housing structure.

4. The apparatus defined in claim 3 wherein the electronic device housing structure comprises metal.

5. The apparatus defined in claim 4 further comprising a radially enlarged portion on the threaded shaft.

6. The apparatus defined in claim 5 further comprising a member that rotates freely with respect to the shaft, wherein the member is retained on the threaded fastener by the enlarged portion.

7. The apparatus defined in claim 2 wherein the threaded fastener comprises a screw with a screw head, the apparatus further comprising:
an additional structure having an unthreaded opening, wherein the threaded shaft passes through the unthreaded opening and wherein the screw head holds the additional structure against the structure with the threaded opening.

8. The apparatus defined in claim 1 wherein the adhesive-filled ball has a diameter of more than 0.2 mm.

9. A method of securing a threaded fastener within a threaded opening, comprising:
inserting an adhesive-filled ball into the threaded opening; and
screwing the threaded fastener into the threaded opening until the adhesive-filled ball bursts and releases thread-locking adhesive to lock the threaded fastener to threads in the threaded opening.

10. The method defined in claim 9 wherein the threaded opening has an opening diameter, and wherein the adhesive filled ball has a ball diameter of at least 80% of the opening diameter.

11. The method defined in claim 9 wherein the adhesive-filled ball has a diameter of more than 0.2 mm.

12. The method defined in claim 11 wherein the diameter of the adhesive-filled ball is 0.6 to 1.1 mm.

13. The method defined in claim 9 wherein inserting the adhesive-filled ball into the threaded opening comprises inserting only a single ball into the threaded opening before screwing the threaded fastener into the threaded opening.

14. The method defined in claim 13 wherein the opening comprises a threaded opening in an electronic device housing and wherein screwing the threaded fastener into the opening comprises screwing the threaded fastener into the threaded opening of the electronic device housing.

15. The method defined in claim 13 wherein the adhesive-filled ball has two chambers filled with two different respective adhesive materials and wherein screwing the threaded fastener into the opening comprises screwing the threaded fastener into the opening until both of the chambers have been ruptured.

16. The method defined in claim 13 wherein the adhesive-filled ball has a reactant coating and wherein inserting the adhesive-filled ball comprises inserting the adhesive-filled ball with the reactant coating into the threaded opening.

17. The method defined in claim 11 wherein inserting the adhesive-filled ball into the threaded opening comprises inserting one of two adhesive-filled balls that are introduced into the threaded open before screwing the threaded fastener into the threaded opening to burst both of the two adhesive-filled balls.

18. Apparatus, comprising:
a threaded fastener,
a structure with a threaded opening that receives the threaded fastener; and
a ruptured adhesive-filled ball having a diameter of at least 0.2 mm in the opening that has released thread-locking adhesive that locks the threaded fastener within the threaded opening.

19. The apparatus defined in claim 18 wherein the structure comprises a metal electronic device housing structure.

20. The apparatus defined in claim 19 further comprising a metal member retained by a radially enlarged portion of the threaded fastener.
